(19) United States
(12) Patent Application Publication
(10) Pub. No.: US 2026/0045845 A1
(43) Pub. Date: Feb. 12, 2026

(54) WINDING, WINDING ASSEMBLY, AND COMPONENT FOR AN ELECTRIC MACHINE

(71) Applicant: ZF FRIEDRICHSHAFEN AG, Friedrichshafen (DE)

(72) Inventors: Kaijun XU, Schonungen (DE); Stefan REUTER, Hammelburg (DE); Dominik BÜTTNER, Hollstadt (DE)

(21) Appl. No.: 19/099,665

(22) PCT Filed: Aug. 2, 2023
(86) PCT No.: PCT/EP2023/071434

§ 371 Date: Jan. 29, 2025

(30) Foreign Application Priority Data
Aug. 3, 2022 (DE) 10 2022 208 037.8

(51) Int. Cl. H02K 3/28; H02K 3/12

(52) U.S. Cl. CPC H02K 3/28; H02K 3/12

(57) ABSTRACT

A winding for an electric machine component, the component has an annular lamination stack with axially extending slots for receiving partial strands of the winding in radially adjacent winding layers. The winding layers have a radially outer layer and a radially inner layer and a second winding layer arranged adjacent the outer layer, a third winding layer adjacent the second winding layer, a fourth winding layer adjacent the third winding layer, and a fifth winding layer adjacent the fourth winding layer and between the fourth winding layer and the inner layer, wherein an average coil pitch of partial strands, which are guided through the inner layer and through the outer layer or through the second winding layer and the third winding layer, differs from another average coil pitch of other partial strands, which other partial strands are guided through the fourth winding layer and the fifth winding layer.

### CROSS REFERENCE TO RELATED APPLICATIONS

This is a U.S. national stage of Application No. PCT/EP2023/071434 filed Aug. 2, 2023. Priority is claimed on German Application No. DE 10 2022 208 037.8 filed Aug. 3, 2022, the contents of which are incorporated herein by reference.

### BACKGROUND OF THE INVENTION

### 1. Field of the Invention

The present disclosure is directed to a winding, a winding arrangement, a component for an electric machine, an electric machine, a transmission device, an electric axle drive, and a motor vehicle.

### 2. Description of the Related Art

Electric machines may include components with windings comprising, for example, copper wires, for conducting electrical energy for generating magnetic fields. The chording between rings of such windings can be implemented as flat wire windings based on additional interconnection elements or lost and additional motion on a complete winding layer of the component. Accordingly, there can be two winding heads of different sizes (axially and radially) outside of the lamination stack.

### SUMMARY OF THE INVENTION

Against this background, one aspect of the present invention provides an improved winding, an improved winding arrangement, an improved component for an electric machine, an improved electric machine, an improved transmission device, an improved electric axle drive, and an improved motor vehicle according to the main claims.

The winding presented herein can advantageously minimize the copper weight for implementing the chording and save material costs. Further, the winding has good manufacturability and a compact interconnection.

A winding for a component of an electric machine is provided in which the component comprises an annular lamination stack with a plurality of slots axially extending through the lamination stack for receiving partial strands of the winding in a plurality of radially adjacently arranged winding layers. The winding layers comprise at least one radially outermost outer layer and a radially innermost inner layer, at least one second winding layer arranged adjacent the outer layer, a third winding layer arranged adjacent the second winding layer, a fourth winding layer arranged adjacent the third winding layer and a fifth winding layer which is arranged adjacent the fourth winding layer and between the fourth winding layer and the inner layer. In this regard, an average coil pitch of partial strands which are guided through the inner layer and through the outer layer or through the second winding layer and the third winding layer differs from another average coil pitch of other partial strands which are guided through the fourth winding layer and the fifth winding layer.

The electric machine can be, for example, an electric drive motor or other electric machine, for example, for a vehicle. The electric machine can comprise various components, such as a rotor and a stator, for example. The component, for example, an annular stator, can be formed from a plurality of individual laminations as a lamination stack through which the slots for receiving the partial strands of the winding extend. The slots can be numbered consecutively along the circumference of the lamination stack so that each slot may be assigned a unique position. Each of the slots can receive a plurality of partial strands which can be arranged radially adjacent in the slot. The quantity of partial strands which can be received by a slot can correspond to a quantity of winding layers. Accordingly, the winding layers can make up different portions of the slots. The winding can be, for example, a flat wire winding, the individual partial strands of which may be formed, for example, as so-called hairpin wires, i.e., as electrically conductive wires with a hairpin-like geometry which can be interconnected with one another on a twist side of the component. Hairpins with different coil pitch can also be used; the coil pitch can depend on the place of use of the respective partial strand. In the winding presented herein, partial strands which are guided through the inner layer, outer layer, second winding layer and third winding layer can have a constant coil pitch, while the coil pitch of other partial strands which are guided through the fourth winding layer and fifth winding layer can vary, for example. “Coil pitch” may be understood as the length of a partial strand of the winding. For example, hairpins in layers 1&N, i.e., in the inner layer and outer layer, and in layers 2 and 3 can have a coil pitch of q*m, where q can correspond to the predetermined hole number of the winding and m can correspond to the quantity of phases used. On the other hand, hairpins in winding layers 4 and 5 and in possible further winding layers, for example, in layers 6 and 7 (given n layers, these can be layers n-1 and n-2), can have an average coil pitch of q*m−s, where s can correspond to the quantity of slots. Accordingly, there can advantageously be hairpins with different coil pitches only in one of layers 4 and 5, 6 and 7 or, generally, n-2 and n-1. Hairpins in each of the remaining layers can have a constant coil pitch. Therefore, time and costs can advantageously be saved in the production of the winding. Further, on the twist side, for example, all of the hairpins can be oriented at the same twist angle, e.g., (q*m−s)/2 slots. Accordingly, a compact interconnection and a reduced winding head height can advantageously be achieved. In this way, the installation space requirement of the entire component and the copper weight can be reduced as a whole.

According to one aspect, the partial strands and, additionally or alternatively, the other partial strands can be interconnected with one another in an alternating manner. The individual partial strands can be inserted, for example, as hairpins, in the corresponding slots in the lamination stack and interconnected with one another at a twist side of the winding. For this purpose, for example, two free end portions of two partial strands can be bent toward one another and, for example, electrically conductively coupled with one another or twisted around one another. For example, a first partial strand can be interconnected with a second partial strand arranged in another winding layer. The second partial strand can in turn be interconnected with a third partial strand in another winding layer, and the third partial strand can in turn be interconnected with a fourth partial strand. In so doing, the interconnection of the individual partial strands can be carried out so as to span layers. The winding can advantageously be optimized.

According to one aspect, a first quantity of partial strands and of other partial strands can be wound along a first main direction of the winding, and a second quantity of partial strands and of other partial strands of the winding can be wound along a second main direction of the winding opposite the first main direction. For example, the winding can comprise eighteen partial strands which can be wound in, for example, six winding layers along the annular lamination stack. Partial strands 1 to 9, for example, can be wound in the first main direction, for example, in clockwise direction, along the ring shape. Partial strands 10 to 18 can then be wound in the opposite, second main direction, i.e., for example, counterclockwise.

According to one aspect, a first partial strand of the other partial strands can have a first input portion, a first output portion and a first connection portion connecting the first input portion and the first output portion. The first input portion can be arranged in a first input slot of the slots and in a first input layer of the winding layers, and the first output portion can be arranged in a first output slot of the slots which is spaced from the first input slot along a circumference of the lamination stack and in a first output layer of the winding layers. The first output portion can be interconnected with a second input portion of a second partial strand of the partial strands, and the second input portion can be arranged in a second input slot of the slots and in a second input layer of the winding layers. The first input portion and the first output portion can be understood, for example, as substantially parallel legs of the hairpin wire which can be connected with one another via the connection portion, for example, at a crown side of the winding. The first input portion and the first output portion can be arranged in different slots at different radial positions and in different winding layers of the lamination stack so that the free ends of the hairpin on the twist side can be arranged radially and, additionally or alternatively, spaced from one another along the circumference. If the lamination stack has, for example, six winding layers, the first input portion can be arranged, for example, in the fourth winding layer. On the crown side, the first input portion can be connected with the first output portion by the first connection portion, for example, over a plurality of slots of the lamination stack, which output portion can be arranged, for example, in the adjacent fifth winding layer of the winding. The first output portion can be interconnected with the second input portion of a similarly formed second partial strand in another winding layer.

Further, the first output layer and the second input layer can be arranged so as to be spaced from one another. For example, the first partial strand can be interconnected with the second partial strand arranged in an adjacent winding layer. The second partial strand can in turn be interconnected with a third partial strand in a winding layer which is again arranged adjacent, and the third partial strand can in turn be interconnected with a fourth partial strand. The interconnection of the individual partial strands can be carried out so as to span layers and follow the respective pattern of the first partial strand and second partial strand. Accordingly, the winding can advantageously be produced with reduced winding head height, low installation space requirement and minimal material expenditure.

According to one aspect, at least one intermediate layer of the winding layers which is different than the first output layer and the second input layer can be arranged between the first output layer and the second input layer. For example, the first partial strand can be guided through the fourth winding layer and fifth winding layer and, proceeding from the fifth winding layer, be interconnected with a second partial strand entering the second winding layer. Accordingly, the third winding layer and fourth winding layer can be arranged between the output layer of the first partial strand in the input layer of the second partial strand.

According to one aspect, a further partial strand of the winding can be guided through a further input slot and a further output slot within the outer layer. When, for example, a first quantity of partial strands is wound along a first main direction of the winding which, for example, can correspond to a clockwise direction around the lamination stack, this winding direction can advantageously be reversed through the positioning of the further partial strand. The further partial strand can enter a further input slot of the outer layer, for example, and exit again in a further output slot spaced from the further input slot along the lamination stack.

Alternatively, the further partial strand can also be guided inside of the inner layer instead of in the outer layer.

Further, a winding arrangement with at least one first partial winding and a second partial winding is presented. The first partial winding and, additionally or alternatively, the second partial winding corresponds to a variant of the previously presented winding. For example, a winding arrangement can comprise two or three partial windings which are wound parallel to one another according to an identical or similar pattern. For example, the same phase can be carried in all of the partial windings.

Further, a component is presented for an electric machine with a variant of the previously presented winding. The component further comprises the annular lamination stack with the plurality of slots axially extending through the lamination stack for receiving the partial strands of the winding in a plurality of radially adjacently arranged winding layers. As a result of this combination, the advantages described above can advantageously be realized in an optimal manner. For example, the component can comprise three of the windings described above in order to carry, for example, three different phases, all of the windings being windable according to the same winding scheme. A compact component with optimized wiring of the individual phases can advantageously be realized in this way.

An electric machine can comprise an aforementioned component which can be constructed either as a stator or as a rotor. For example, the component can comprise three of the aforementioned windings.

The electric machine is suitable, for example, for an electric axle drive. Such an electric axle drive for a motor vehicle comprises at least one aforementioned electric machine, a transmission device and a power converter. The power converter can be constructed, for example, as an inverter. An electric current required for the operation of the electric machine can be supplied using the power converter. A torque provided by the electric machine can be transformed into a drive torque for driving at least one wheel of the motor vehicle using the transmission device. The transmission device can have a transmission for reducing the speed of the electric machine and, optionally, a differential.

Correspondingly, a motor vehicle can comprise an aforementioned electric machine and, additionally or alternatively, an aforementioned electric axle drive.

### BRIEF DESCRIPTION OF THE DRAWINGS

The invention will be described in more detail by way of example referring to the accompanying drawings. The drawings show:

FIG. 1 is a schematic side view of a component of an electric machine with a winding;

FIG. 2A is a schematic fragmentary view of a winding;

FIG. 2B is a schematic fragmentary view of a;

FIG. 3 is a tabular representation of a winding scheme for a winding;

FIG. 4 is a tabular representation of a further winding scheme for a winding;

FIG. 5A is a schematic diagram of a further winding scheme;

FIG. 5B is a schematic diagram of a further winding scheme;

FIG. 6 is a tabular representation of of an additional winding scheme for a winding;

FIG. 7 is a schematic view of a first partial strand;

FIG. 8 is a schematic detail view of a component with a winding;

FIG. 9a is a schematic cross-sectional view of a component with a winding;

FIG. 9b is a schematic top view of of a component with a winding from the twist side;

FIG. 9c is a schematic top view of a component with a winding from the crown side;

FIG. 10a is a schematic cross-sectional view of a component with a winding;

FIG. 10b is a schematic top view of a component with a winding from the twist side;

FIG. 10c is a schematic top view of a component with a winding from the crown side; and

FIG. 11 is a schematic view of a motor vehicle.

### DETAILED DESCRIPTION OF THE PRESENTLY PREFERRED EMBODIMENTS

In the following description of preferred exemplary embodiments of the present invention, the same or like reference numerals are used for the elements illustrated in the various figures having similar functionality so as to avoid a repetitive description of these elements.

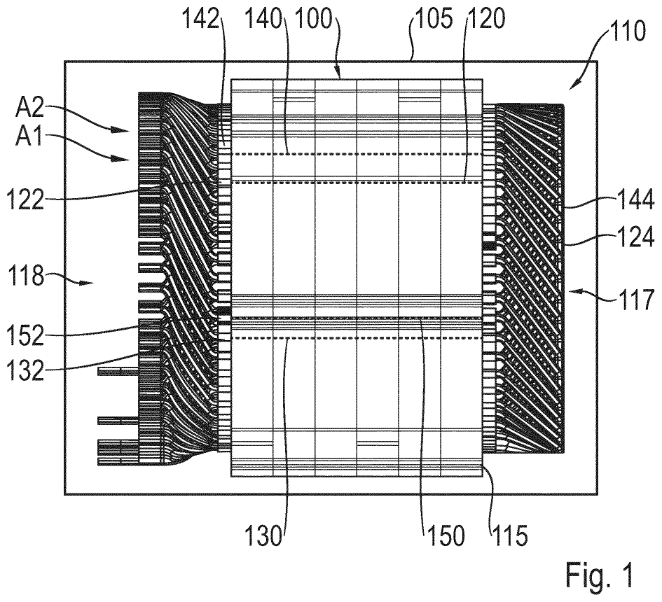

FIG. 1 shows a schematic side view of a component 100 of an electric machine 105 with a winding 110. Component 100 is formed, merely by way of example, as a stator and comprises an annular lamination stack 115 with a plurality of slots axially extending through the lamination stack for receiving partial strands of the winding 110 in a plurality of radially adjacently arranged winding layers. The winding layers comprise a radially outermost outer layer, a radially innermost inner layer, a second winding layer arranged adjacent the outer layer, a third winding layer arranged adjacent the second winding layer, a fourth winding layer arranged adjacent the third winding layer, and a fifth winding layer which is arranged adjacent the fourth winding layer and between the fourth winding layer and the inner layer.

The partial strands of winding 110 are formed, merely by way of example, as flat wires with a hairpin-like geometry for conducting a flow of electrical energy and may therefore also be referred to as hairpins or hairpin wires. By way of example, every hairpin has two portions or legs which are guided in each instance through a slot of the lamination stack and are connected with one another at a crown side 117 of component 100. The free ends of each hairpin wire are interconnectable with another wire at a twist side 118 opposite crown side 117.

Winding 110 comprises, merely by way of example, a first partial strand A1 which is arranged with a first input portion 120 in a first input slot 122. In this exemplary embodiment, first input portion 120 is positioned within first input slot 122 in a first input layer. Merely by way of example, the first input layer is the fourth winding layer of winding A.

At crown side 117, first input portion 120 of first partial strand A1 is connected, merely by way of example, with a first output portion 130 by a first connection portion 124. In an exemplary embodiment, first output portion 130 is arranged in a first output slot 132 and leads therein from crown side 117 to twist side 118 substantially parallel to first input portion 120. The first output slot 132 is arranged to be spaced from first input slot 122 along a circumference of lamination stack 115. In an exemplary embodiment, first input slot 122 and first output slot 132 are arranged seven slots apart from one another in lamination stack 115. Further, first output portion 130 is positioned within first output slot 132, merely by way of example, in a first output layer in which, in an exemplary embodiment, it is the fifth winding layer of winding 110.

First output portion 130 is interconnected, for example, with a second input portion 140 of second partial strand A2. In one aspect, the second input portion 140 is arranged in a second input slot 142 in a second input layer, and second input slot 142 is positioned, for example, to be spaced from first input slot 122 and first output slot 132. In an exemplary embodiment, the second input layer corresponds to the second winding layer arranged adjacent the outer layer. Merely by way of example, second input portion 142 is connected via a second connection portion 144 to a second output portion 150. Second output portion 150 is arranged in a second output slot 152 which is positioned to be spaced from first input slot 122, first output slot 132 and second input slot 142 along the circumference of lamination stack 115. In this exemplary embodiment, second output portion 150 is arranged within second output slot 152 in a second output layer. The second output layer corresponds, merely by way of example, to the third winding layer arranged between the second winding layer and the fourth winding layer.

In one aspect, second input slot 142 and first output slot 152 are arranged at a distance of nine slots from one another in lamination stack 115. Consequently, the coil pitch of second partial strand A2 is greater than the coil pitch of first partial strand A1.

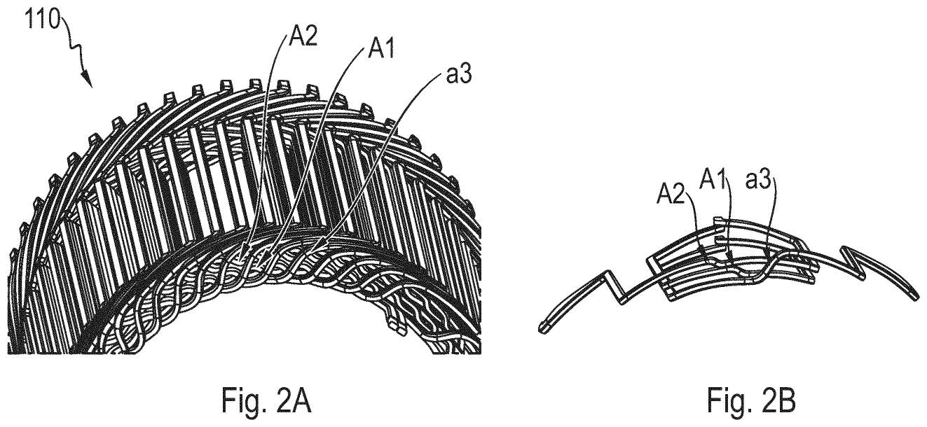

FIGS. 2A and 2B show a schematic fragmentary view of a winding 110. The winding 110 shown here corresponds to, or is similar to, the winding described in the preceding figure and comprises a first partial strand A1, a second partial strand A2 and a third partial strand a3. In the illustration shown here, the lamination stack described in FIG. 1 and the slots arranged therein for receiving partial strands A1, A2, a3 are not shown so as to make individual partial strands A1, A2, a3 more visible.

In this example, first partial strand A1 is guided through the fourth winding layer and fifth winding layer of winding 110 and spans, for example, seven slots. In contrast, second partial strand A2 which is guided in this exemplary embodiment through the second winding layer and third winding layer spans nine slots merely by way of example. Similarly, third partial strand a3 which is guided through the outer layer and the inner layer of winding 110 in this exemplary embodiment likewise spans nine slots, for example. Correspondingly, an average coil pitch of second partial strand A2 and third partial strand a3 is greater than the coil pitch of first partial strand A1.

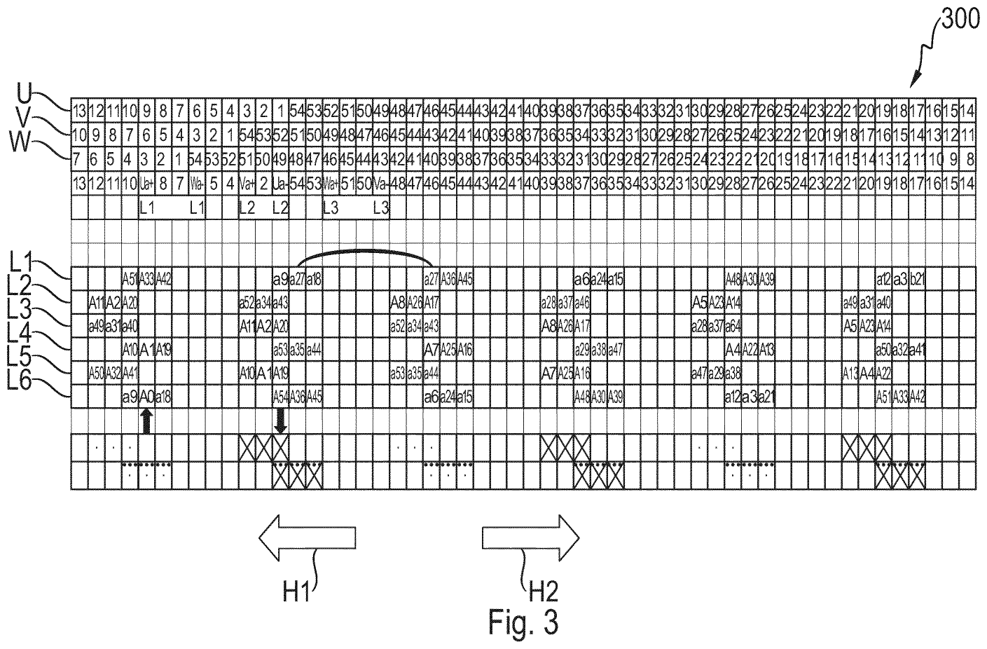

FIG. 3 shows a tabular representation of a winding scheme 300 for a winding such as was described in the preceding figures. The winding scheme 300 shown here is configured, for example, for a component with a lamination stack with, by way of example, fifty-four slots and a hole number 3 for receiving a total of three windings in which, by way of example, phases U, W and V can be carried. Positions 1 to 54 of the slots along the circumference of the lamination stack are indicated in the top three rows of the table. The row at the top corresponds to a variant of the above-described winding carrying the U phase, the row below that corresponds to a variant of the above-described winding carrying the W phase, and the row below that corresponds to a variant of the above-described winding carrying the V phase. The positions of the respective connections of the individual phases are indicated in the fourth row, and the interconnection of the connections is indicated below that in the fifth row.

The six rows below the position markings correspond to, by way of example, six winding layers of the winding. The top row corresponds to the radially outermost outer layer L1 of the winding. Second winding layer L2 is arranged adjacent outer layer L1. Second winding layer L2 is arranged in the table shown here below outer layer L1 and is meant as a winding layer arranged radially adjacent outer layer L1 in the lamination stack. Similarly, the row below that designates third winding layer L3 arranged radially adjacent second winding layer L2. Similarly, the row below that designates fourth winding layer L4 arranged radially adjacent third winding layer L3, and the row below that designates fifth winding layer L5 arranged radially adjacent fourth winding layer L4. The fifth winding layer L5 is arranged between fourth winding layer L4 and radially innermost inner layer L6 of the winding, the latter being designated in the table shown here by the row below the fifth winding layer L5. Inputs and outputs of partial strands of the winding are marked proceeding from a twist side of the winding in the bottom two rows of winding scheme 300.

In one aspect, winding scheme 300 is represented, merely by way of example, based on a winding of the U phase. The remaining windings are windable according to the same scheme.

In one aspect, the first input portion of first partial strand A1 such as was described in the preceding FIG. 1 is arranged at a first input position 2 in a first input slot of the slots and in a first input layer of the winding layers. Merely by way of example, the first input layer corresponds to fifth winding layer L5 of the winding layers, and first input position 2 corresponds to a position of the consecutively numbered fifty-four slots along the circumference of the winding. The first output portion of first partial strand A1 is arranged, for example, at a first output position 9 in a first output slot of the slots which is spaced apart from the first input slot along a circumference of the lamination stack and is arranged in a first output layer of the winding layers. In this exemplary embodiment, the first output layer corresponds to fourth winding layer L4. In an exemplary embodiment, input position 2 of first partial strand A1 is spaced from output position 9 by seven slots and, by way of example, is arranged in an output layer adjacent the input layer.

In one aspect, the first output portion of first partial strand A1 is interconnected with a second input portion of second partial strand A2 of the partial strands. The second input portion is arranged, by way of example, in third winding layer L3 which is arranged adjacent fourth winding layer L4. The second input portion is arranged, for example, at a second input position 2. Second input position 2 of second partial strand A2 corresponds to first input position 2 of first partial strand A1, as a result of which the first input portion and the second input portion are arranged along the circumference of the lamination stack at the same position, but in winding layers L3, L5 which are radially spaced from one another. The first output portion of first partial strand A1 and the second input portion of second partial strand A2 are arranged, by way of example, at a distance of seven slots from one another. Correspondingly, the portions are interconnected with one another by 3.5 twist steps, since this corresponds to one half of the quantity of the slots to be spanned.

In this example, the second output portion of second partial strand A2 is arranged in second winding layer L2 at a second output position 11, which second winding layer L2 is arranged adjacent third winding layer L3. Second output position 11 is arranged to be spaced from second input position 2, for example, by nine slots. Correspondingly, second partial strand A2 has a greater coil pitch than first partial strand A1.

In one aspect, the second output portion of second partial strand A2 is interconnected with a third input portion of a third partial strand a3 of the partial strands. In this exemplary embodiment, the third input portion is arranged at a third input position 18 in outer layer L1. In an exemplary embodiment, third partial strand a3 spans winding layers L2, L3, L4, L5 which are arranged between outer layer L1 and inner layer L6. A third output position 27 of a third output portion of the third partial strand is arranged at a distance of nine slots from third input position 18. Consequently, a coil pitch of third partial strand a3 corresponds to the coil pitch of second partial strand A2 but differs from the coil pitch of first partial strand A1.

Proceeding from inner layer L6, third partial strand a3 is interconnected, merely by way of example, with a fourth partial strand A4 of the other partial strands which, by way of example, similar to first partial strand A1, enters in fifth winding layer L5 and exits in fourth winding layer L4. A fourth input position 20 of fourth partial strand A4 is arranged at a distance of, for example, eight slots from a fourth output position 28 of fourth partial strand A4.

Fourth partial strand A4 is interconnected, for example, with a fifth partial strand A5 of the partial strands which enters in third winding layer L3 and exits in second winding layer L2 similar to second partial strand A2.

The rest of the partial strands and other partial strands of the winding are wound corresponding to the above-described scheme and are interconnected with one another in an alternating manner. In an exemplary embodiment, a first half of the partial strands and of the other partial strands is wound along a first main direction H1 of the winding, and a second half of the partial strands and of the other partial strands of the winding is wound along a second main direction H2 of the winding opposite the first main direction. In an exemplary embodiment, a further partial strand a27 of the winding is guided through a further input slot and a further output slot within outer layer L1 in order to reverse the winding direction. Further partial strand a27 is interconnected, merely by way of example, with a twenty-eighth partial strand a28 of the partial strands which enters in second winding layer L2 and exits in third winding layer L3 in an exemplary embodiment. An input position and an output position of twenty-eighth partial strand a28 are arranged at a distance of nine slots from one another. This twenty-eighth partial strand a28 is in turn interconnected by way of example with a twenty-ninth partial strand a29 of the other partial strands which enters in fourth winding layer L4 and exits from fifth winding layer L5 in an exemplary embodiment. An input position and an output position of twenty-ninth partial strand a29 are arranged at a distance of eight slots from one another in an exemplary embodiment.

On the whole, in the winding scheme 300 shown here, input positions and output positions of partial strands which are guided through inner layer L6 and through outer layer L1 and of partial strands which are guided through the second winding layer and the third winding layer are arranged at a distance of, e.g., nine slots from one another in each instance. In contrast, other partial strands which are guided through fourth winding layer L4 and fifth winding layer L5 vary with respect to the distance between the respective input positions and output positions but have an average distance of, e.g., seven slots. This means that an average coil pitch of partial strands which are guided through the inner layer and through the outer layer or through the second winding layer and the third winding layer differs from another average coil pitch of other partial strands, which other partial strands are guided through the fourth winding layer and the fifth winding layer.

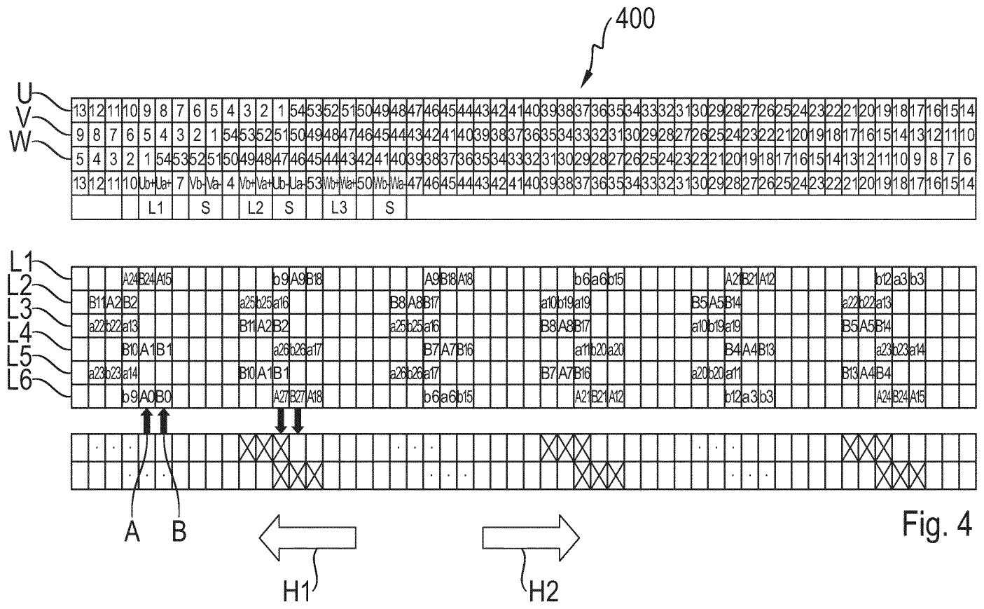

FIG. 4 is a tabular representation of an exemplary embodiment of a further winding scheme 400 for a winding arrangement with a first partial winding A and a second partial winding B. The two partial windings A, B in this exemplary embodiment correspond to a winding such as was described in the preceding FIGS. 1 and 2.

The winding scheme 400 shown here is configured, by way of example, for a component with a lamination stack with, e.g., fifty-four slots and a hole number 3 for receiving a total of three windings in which, by way of example, phases U, W and V can be carried. Positions 1 to 54 of the slots along the circumference of the lamination stack are indicated in the top three rows of the table. The row at the top corresponds to a variant of the above-described winding carrying the U phase, the row below that corresponds to a variant of the above-described winding carrying the W phase, and the row below that corresponds to a variant of the above-described winding carrying the V phase. The positions of the respective connections of the individual phases are indicated in the fourth row, and the interconnection of the connections is indicated below that in the fifth row.

The six rows below the position markings correspond to, by way of example, six winding layers of the winding. The top row corresponds to the radially outermost outer layer L1 of the winding. Second winding layer L2 is arranged adjacent outer layer L1. In the table shown here, second winding layer L2 is arranged below outer layer L1 and is meant as winding layer arranged radially adjacent outer layer L1 in the lamination stack. Similarly, the row below that designates third winding layer L3 which is arranged radially adjacent second winding layer L2. Similarly, the row below that designates fourth winding layer L4 which is arranged radially adjacent third winding layer L3, and the row below that designates fifth winding layer L5 which is arranged radially adjacent fourth winding layer L4. Fifth winding layer L5 is arranged between fourth winding layer L4 and radially innermost inner layer L6 of the winding, the latter being designated in the table shown here by the row below fifth winding layer L5. Inputs and outputs of partial strands of the winding are marked proceeding from a twist side of the winding in the bottom two rows of winding scheme 400.

In one aspect, winding scheme 400 is represented, merely by way of example, based on a winding arrangement for carrying the U phase.

The further winding scheme 400 shown here corresponds to the winding scheme described in the preceding FIG. 3 with the difference that the winding arrangement comprises two parallel partial windings A, B with, in each instance, twenty-seven partial strands and other partial strands which are interconnected in an alternating manner. Partial windings A, B may also be designated as paths or branches. Merely by way of example, eight of the partial strands and other partial strands are wound along the first main direction H1 in first partial winding A. Correspondingly, there is a reversal of direction of partial winding A, for example, already after one third of the partial strands and other partial strands. In this exemplary embodiment, in order to reverse the winding direction, a first further partial strand A9 of partial winding A is guided through a first further input slot and a first further output slot within outer layer L1. Merely by way of example, partial strands and other partial strands adjoining first further partial strand A9 are wound along the second main direction H2.

In one aspect, in second partial winding B, seventeen of the total of twenty-seven partial strands and other partial strands which are interconnected with one another in an alternating manner are wound along first main direction H1. Correspondingly, there is a reversal of direction of second partial winding B, for example, after two thirds of the partial strands and other partial strands of second partial winding B. In this exemplary embodiment, in order to reverse the winding direction, a second further partial strand B18 of second partial winding B is guided through a second further input slot and a second further output slot within outer layer L1. Merely by way of example, partial strands and other partial strands adjoining second further partial strand B18 are wound along second main direction H2.

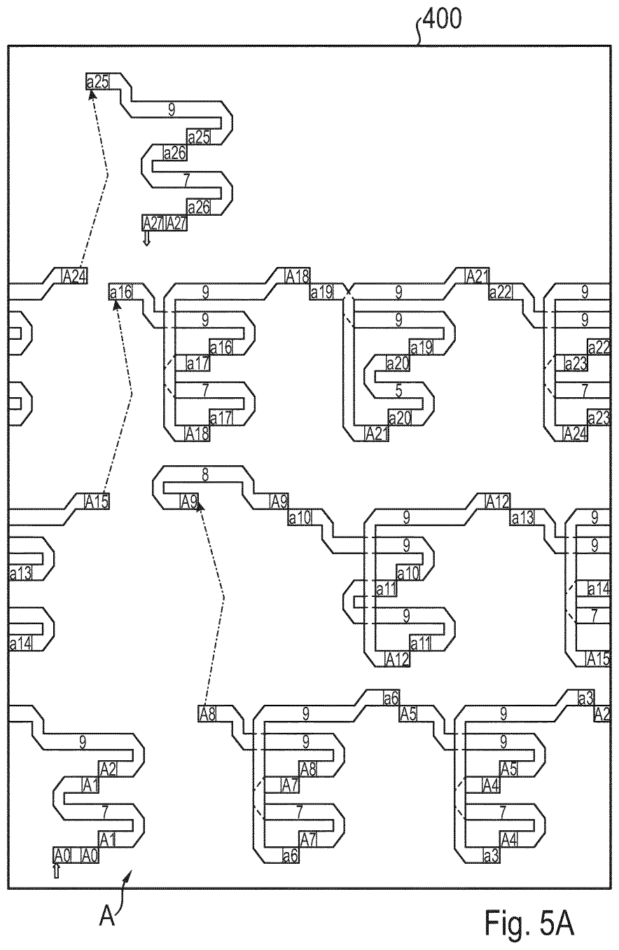

FIGS. 5A and 5B each show a schematic view of a further winding scheme 400. The further winding scheme 400 shown here corresponds to, or is similar to, the winding scheme described in the preceding FIG. 4. First partial winding A is shown by way of example in FIG. 5A, and second partial winding B is shown by way of example in FIG. 5B.

In partial winding A, partial strands A2, a3, A5, A6, A8, a10, A12, a13, A15, a16, A18, A19, A21, a22, A24, a25 which are guided through the inner layer and through the outer layer or through the second winding layer and third winding layer have a coil pitch of, for example, nine slots in each instance. The coil pitch of other partial strands A1, A4, A7, a11, a14, a17, a20, a23, a26 of first partial winding A which are guided through the fourth winding layer and the fifth winding layer vary in an exemplary embodiment between five slots, seven slots and nine slots, where the average is seven slots. Similarly, partial strands B2, b3, B5, B6, B8, b9, B11, B12, B14, b15, B17, B19, B21, B22, B24, b25 of the second partial winding B which are guided through the inner layer and through the outer layer or through the second winding layer and third winding layer also have, in each instance, a coil pitch of, for example, nine slots. The coil pitch of other partial strands B1, B4, B7, B10, B13, B16, b20, b23, b26 of second partial winding B which are guided through the fourth winding layer and fifth winding layer vary in an exemplary embodiment between five slots, seven slots and nine slots, where an average is seven slots.

In other words, a winding arrangement with s=2 slots chording, pole pair number p=3, hole number q=3, number of phases=3 and n=6 layers is shown in FIGS. 5A and 5B. Hairpins in layers 1 and 6 and layers 2 and 3 have a coil pitch of q*m, i.e., for example, 3*3. Hairpins in other layers (for example, 4 and 5) have an average coil pitch of q*m−s, i.e., for example, 3*3−2. Correspondingly, hairpins with different coil pitches are only in one of layers 4 and 5. Hairpins in each of the rest of the layers have a constant coil pitch. Accordingly, only a few hairpin variants are necessary. On the twist side, all of the hairpins have the same twist angle of (q*m−s)/2 slots, i.e., for example, (3*3−2)/2=3.5 slots.

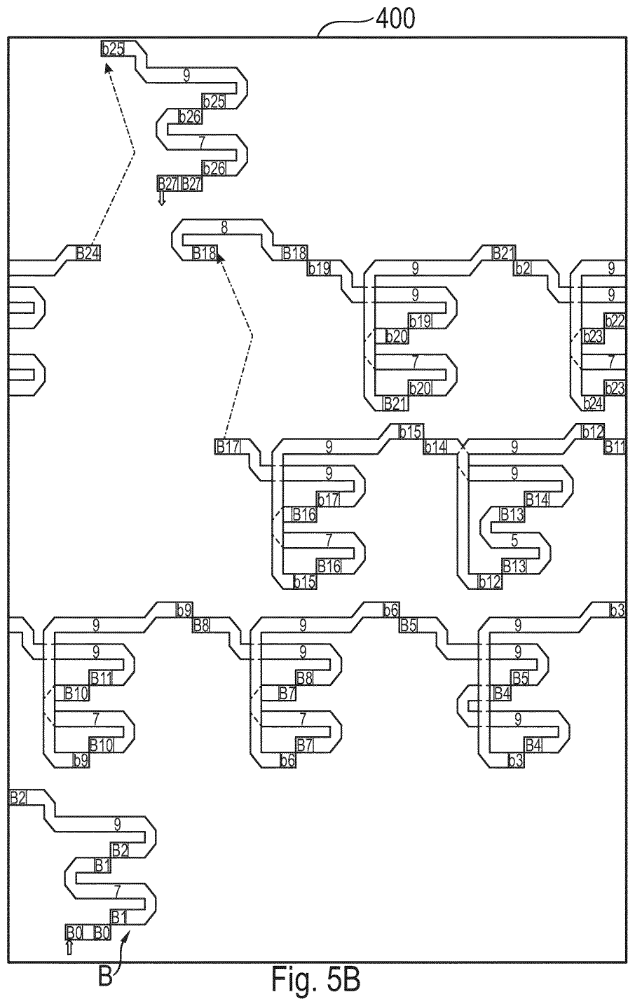

FIG. 6 shows a tabular representation of an exemplary embodiment of an additional winding scheme 600 for a winding arrangement with a first partial winding A, a second partial winding B and a third partial winding D. In this exemplary embodiment, partial windings A, B, D correspond to a winding such as was described in the preceding FIGS. 1 and 2.

The additional winding scheme 600 shown here is configured, by way of example, for a component with a lamination stack with, e.g., fifty-four slots and a hole number 3 for receiving a total of three windings in which, by way of example, phases U, W and V can be carried. Positions 1 to 54 of the slots along the circumference of the lamination stack are indicated in the top three rows of the table. The row at the top corresponds to a variant of the above-described winding carrying the U phase, the row below that corresponds to a variant of the above-described winding carrying the W phase, and the row below that corresponds to a variant of the above-described winding carrying the V phase. The positions of the respective connections of the individual phases are indicated in the fourth row, and the interconnection of the connections is indicated below that in the fifth row.

The six rows below the position markings correspond, for example, to six winding layers of the winding. The top row corresponds to the radially outermost outer layer L1 of the winding. Second winding layer L2 is arranged adjacent outer layer L1. In the table shown here, second winding layer L2 is arranged below outer layer L1 and is meant as winding layer arranged radially adjacent outer layer L1 in the lamination stack. Similarly, the row below that designates third winding layer L3 which is arranged radially adjacent second winding layer L2. Similarly, the row below that designates fourth winding layer L4 which is arranged radially adjacent third winding layer L3, and the row below that designates fifth winding layer L5 which is arranged radially adjacent fourth winding layer L4. Fifth winding layer L5 is arranged between fourth winding layer L4 and radially innermost inner layer L6 of the winding, the latter being designated in the table shown here by the row below fifth winding layer L5. Inputs and outputs of partial strands of the winding are marked proceeding from a twist side of the winding in the bottom two rows of additional winding scheme 600.

In one aspect, further winding scheme 600 is based, merely by way of example, on a winding arrangement for carrying the U phase. First partial winding A, second partial winding B and third partial winding D have in each instance, merely by way of example, eighteen partial strands and other partial strands which are guided parallel to one another. The additional winding scheme 600 is described in the following based on first partial winding A. Second partial winding B and third partial winding D are arranged, respectively, along the circumference of the lamination stack offset by one position relative to first partial winding A.

In one aspect, the first input portion of first partial strand A1 of the other partial strands of partial winding A is arranged at a first input position 1 in a first input slot of the slots and in a first input layer of the winding layers. Merely by way of example, the first input layer corresponds to fourth winding layer L4, and first input position 1 corresponds to a position of the consecutively numbered fifty-four slots along the circumference of the winding. The first output portion of first partial strand A1 is arranged, for example, at a first output position 47 in a first output slot of the slots which is spaced from the first input slot along a circumference of the lamination stack and arranged in a first output layer of the winding layers. In this exemplary embodiment, the first output layer corresponds to fifth winding layer L5. Merely by way of example, first input position 1 is arranged to be spaced from first output position 47 by eight slots.

In one aspect, the first output portion of first partial strand A1 is interconnected with a second input portion of second partial strand A2 of the partial strands of partial winding A. The second input portion is arranged, for example, in second winding layer L2 and in a second input position 3, as a result of which two intermediate layers of the winding layers which are different than the first output layer and the second input layer are arranged between the first output layer and the second input layer. In one aspect, second input position 3 is arranged to be spaced from first output position 47 by ten slots. Correspondingly, the partial strands are connectable with one another by five twist steps because this corresponds to one half of the quantity of slots to be spanned.

In one aspect, the second output portion of second partial strand A2 is arranged in third winding layer L3 at a second output position 48. Second output position 48 is arranged to be spaced from second input position 3 by nine slots merely by way of example. Accordingly, second partial strand A2 has a greater coil pitch than first partial strand A1. The second output portion is in turn interconnected with the third input portion of third partial strand a3 of the partial strands of partial winding A. The third input portion is arranged at a third input position 19 in inner layer L6. In this exemplary embodiment, third input position 19 is arranged spaced from the second output portion by twenty-five slots, as a result of which second partial strand A2 and third partial strand a3 are interconnectable with one another, respectively, by 12.5 twist steps. The third output portion of third partial strand a3 is arranged, merely by way of example, at a third output position 10 in outer layer L1. In this exemplary embodiment, third output position 10 is arranged to be spaced from third input position 19 by nine slots. Accordingly, third partial strand a3 has the same coil pitch as second partial strand A2, which differs from the coil pitch of first partial strand A1.

In one aspect, third partial strand a3 is interconnected with fourth partial strand A4 which, similar to first partial strand A1, enters in fourth winding layer L4 and exits in fifth winding layer L5. The input position and the output position of fourth partial strand A4 have a spacing of five slots by way of example. In this exemplary embodiment, partial strand A5 which is interconnected with fourth partial strand A4 is, like second partial strand A2, guided again from second winding layer L2 to third winding layer L3 and is interconnected with a sixth partial strand a6 which, like third partial strand a3, is guided from inner layer L6 to outer layer L1. Following this pattern, a seventh partial strand A7 is guided, merely by way of example, from fourth winding layer L4 to fifth winding layer L5 and is interconnected with an eighth partial strand A8 which is again guided from second winding layer L2 to third winding layer L3.

In one aspect, the above-described first half of partial strands A2, a3, A5, a6, A8 and of other partial strands A1, A4, A7 of partial winding A is wound along a first main direction H1 of the winding. A second half of partial strands a10, A12, a13, A15, a16 and of other partial strands a11, a14, a17 of the winding is wound, for example, along a second main direction H2 of the winding opposite first main direction H1. A reversal of direction takes place by a further partial strand A9, of which the input portion and output portion are both guided, for example, through outer layer L1. Partial strands a10, A12, a13, A15, a16 and other partial strands a11, a14, a17 which adjoin further partial strand A9 follow the above-described winding scheme, except that they are wound in the opposite direction from partial strands A2, a3, A5, a6, A8 and other partial strands A1, A4, A7 of the first half. Correspondingly, for example, partial strands a10, A12, a13, A15, a16 lead from third winding layer L3 to second winding layer L2 or from outer layer L1 to inner layer L6. Other partial strands a11, a14, a17 lead, for example, from fifth winding layer L5 to fourth winding layer L4.

The input positions and the output positions of partial strands A2, a3, A5, a6, A8, a10, A12, a13, A15, a16 which are guided through the inner layer and through the outer layer or through the second winding layer and the third winding layer are arranged in each instance to be spaced from one another along the circumference of the lamination stack, for example, by nine slots. In contrast, the spacing between the input positions and the output positions of other partial strands A1, A4, A7, a11, a14, a17 which are guided through the fourth winding layer and the fifth winding layer varies, for example, between five slots and eight slots, with an average spacing of seven slots. Correspondingly, in this exemplary embodiment an average coil pitch of partial strands A2, a3, A5, a6, A8, a10, A12, a13, A15, a16 is greater than an average coil pitch of other partial strands A1, A4, A7, a11, a14, a17.

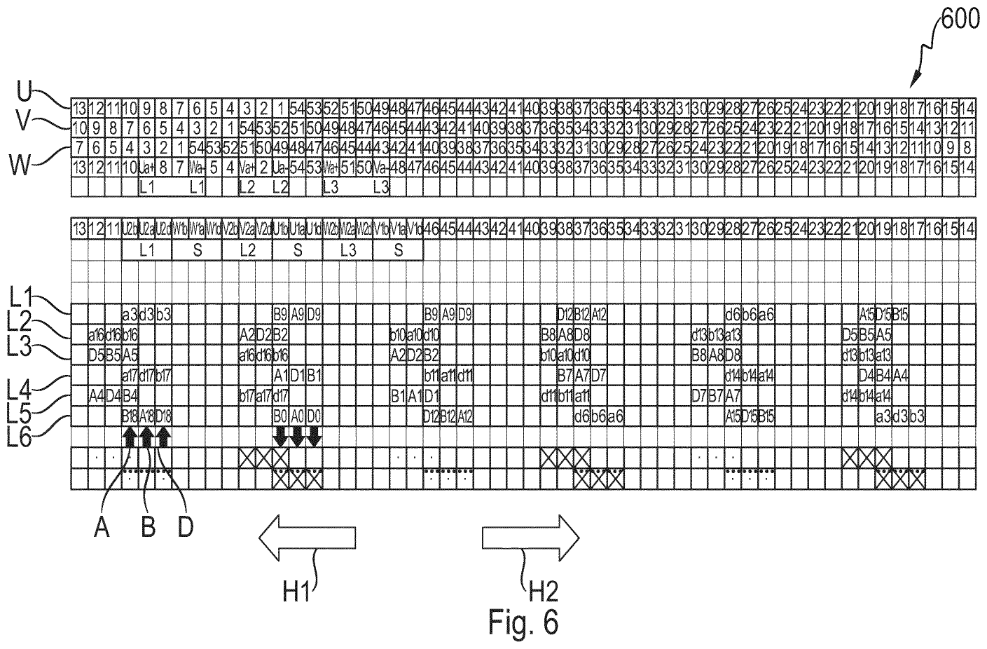

FIG. 7 shows a schematic view of a first partial strand A1. The first partial strand A1 shown here corresponds to, or is similar to, the first partial strand described in the preceding figures and is usable in a winding such as was described in the preceding FIGS. 1 and 2. In this exemplary embodiment, first partial strand A1 is formed as flat wire from a copper material for conducting electrical energy and has a hairpin-like geometry. First partial strand A1 comprises a first input portion 120 and a first output portion 130 for guiding through a slot of a lamination stack of a component. First input portion 120 and first output portion 130 are connected by a first connection portion 124.

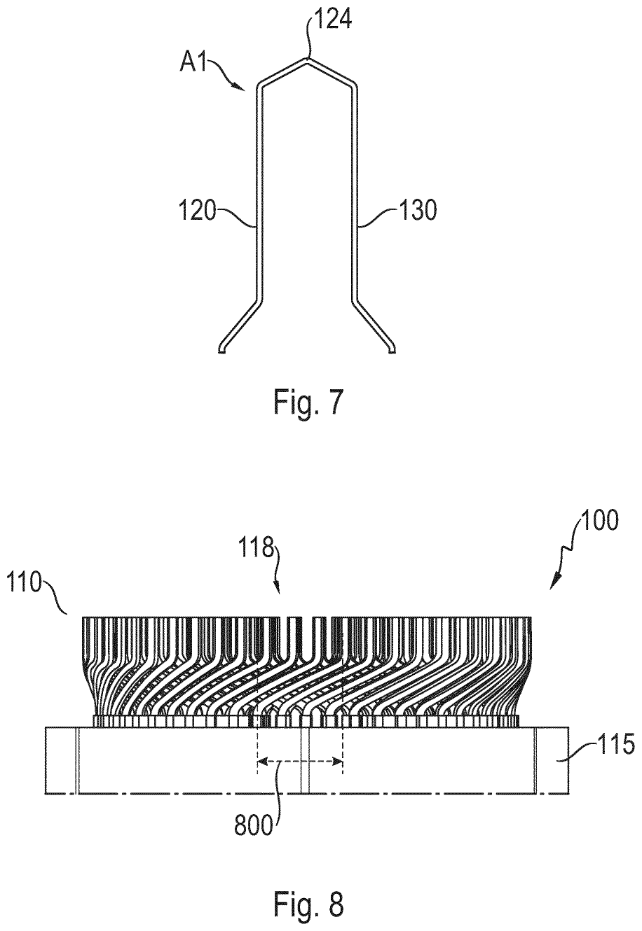

FIG. 8 shows a schematic detail view of a component 100 with a winding 110. The component 100 shown here and the depicted winding 110 correspond to, or are similar to, the component and winding described in the preceding FIGS. 1 and 2. In this exemplary embodiment, winding 110 is shown from the twist side 118. In this exemplary embodiment, the individual partial strands of winding 110 are interconnected with one another, respectively, in a twist angle 800 of, for example, 3.5 slots.

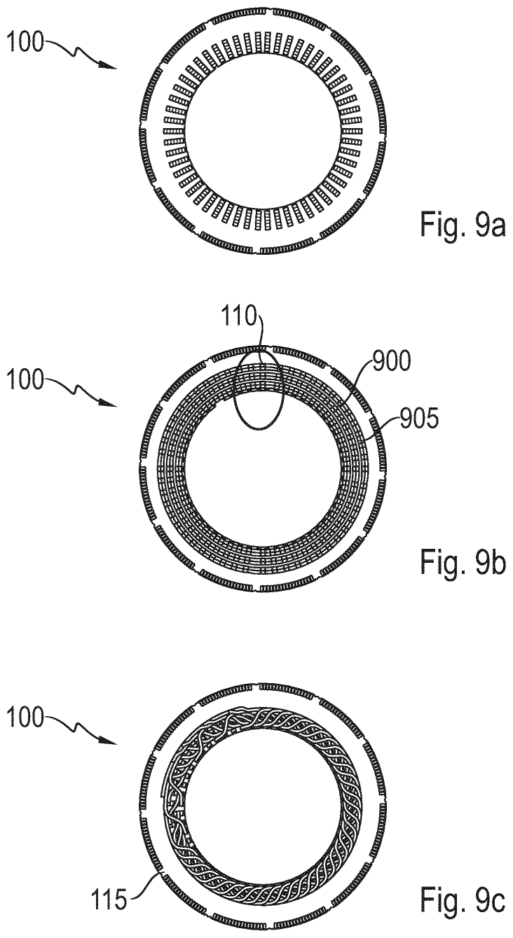

FIGS. 9a, 9b and 9c each show a schematic view of a component 100 with a winding 110. FIG. 9a shows a cross-section, FIG. 9b shows a top view from the twist side, and FIG. 9c shows a top view from the crown side. The component 100 shown here and the depicted winding 110 correspond to, or are similar to, the component and winding described in the preceding FIGS. 1, 2 and 8.

In one aspect, annular lamination stack 115 of component 100 comprises, for example, six winding layers arranged radially adjacent one another for receiving winding 110 in which, merely by way of example, a U phase can be carried. In one aspect, lamination stack 115 is also formed to receive a further winding 900 in which, merely by way of example, a W phase can be carried, and an additional winding 905 in which, merely by way of example, a V phase can be carried.

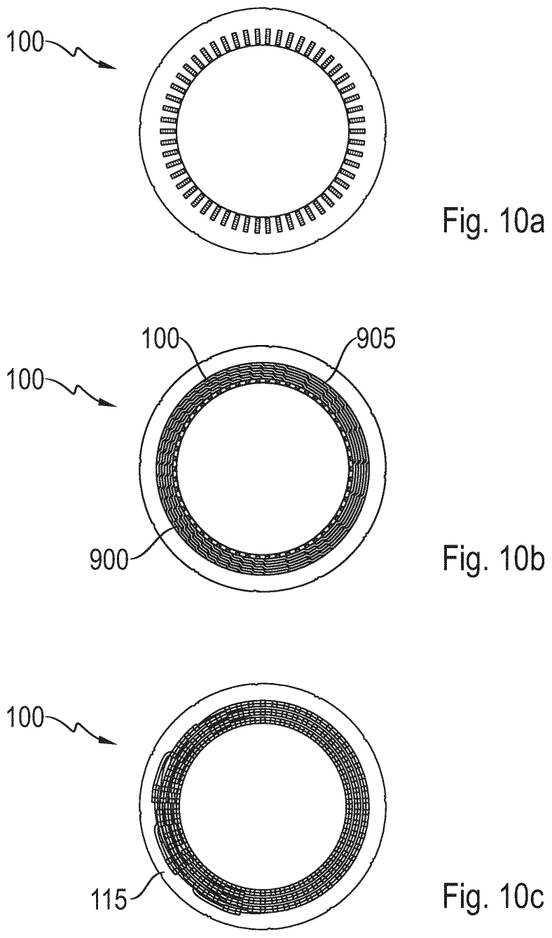

FIGS. 10a, 10b and 10c each show a schematic view of a component 100 with a winding 110. FIG. 10a shows a cross-section, FIG. 10b shows a top view from the twist side and FIG. 10c shows a top view from the crown side. The component 100 shown here and the depicted winding 110 correspond to, or are similar to, the component and winding described in the preceding FIGS. 1, 2, 8 and 9.

In this exemplary embodiment, annular lamination stack 115 of component 100 comprises, for example, six winding layers which are arranged radially adjacent one another for receiving winding 110 in which, merely by way of example, a U phase can be carried. In one aspect, lamination stack 115 is also formed to receive a further winding 900 in which, merely by way of example, a W phase can be carried, and an additional winding 905 in which, merely by way of example, a V phase can be carried.

Windings 110, 900, 905 in FIGS. 10a and 10c differ from the corresponding windings shown in the preceding FIGS. 9a and 9c in that windings 110, 900, 905 in FIGS. 10a and 10c which carry the different phases are arranged adjacent one another along the circumference of lamination stack 115, while the windings in the preceding FIGS. 9a, 9c are arranged to be interwoven along the circumference.

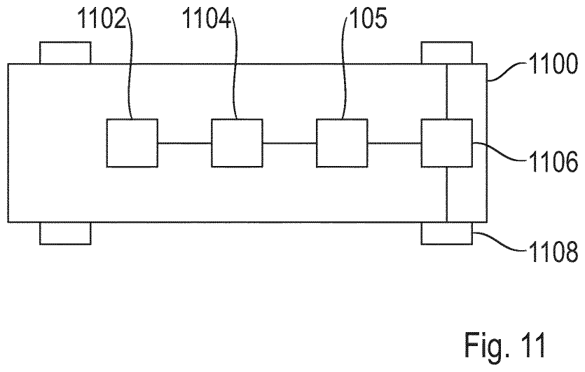

FIG. 11 shows a schematic view of a motor vehicle 1100. The motor vehicle has an electric axle drive with an electric machine 105 such as was described by way of example referring to the preceding FIG. 1. Electrical energy for the operation of electric machine 105 is supplied by a power supply device 1102, for example, a battery. By way of example, a DC current provided by power supply device 1102 is converted into an AC current, for example, a three-phase AC current, using a power converter 1104 of the transmission device and is supplied to electric machine 105. A shaft driven by electric machine 105 is coupled directly, or with the use of a transmission device 1106, to at least one wheel 1108 of motor vehicle 1100. Accordingly, motor vehicle 1100 can be moved by electric machine 105. According to an exemplary embodiment, the electric axle drive comprises a housing in which power converter 1104, electric machine 105 and transmission device 1106 are integrated.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A winding for a component of an electric machine, wherein the component comprises an annular lamination stack with a plurality of axially extending slots through the lamination stack, the winding comprising:
partial strands of the winding received in the axially extending slots in a plurality of radially adjacently arranged winding layers, wherein the winding layers comprise:
at least one radially outermost outer layer;
a radially innermost inner layer;
at least one second winding layer arranged adjacent the outer layer;
a third winding layer arranged adjacent the second winding layer;
a fourth winding layer arranged adjacent the third winding layer; and
a fifth winding layer which is adjacent the fourth winding layer and is arranged between the fourth winding layer and the inner layer,
wherein an average coil pitch of partial strands of the winding which are guided through the inner layer and through the outer layer or through the second winding layer and the third winding layer differs from another average coil pitch of other partial strands of the winding,
wherein the other partial strands are guided through the fourth winding layer and the fifth winding layer.

14. The winding according to claim 13, wherein the partial strands and/or the other partial strands are interconnected with one another in an alternating manner.

15. The winding according to claim 13, wherein a first quantity of partial strands and of other partial strands is wound along a first main direction of the winding, and a second quantity of partial strands and of other partial strands of the winding is wound along a second main direction of the winding opposite the first main direction.

16. The winding according to claim 13, wherein a first partial strand of the other partial strands has a first input portion, a first output portion and a first connection portion connecting the first input portion and the first output portion, wherein the first input portion is arranged in a first input slot of the slots and in a first input layer of the winding layers, and the first output portion is arranged in a first output slot of the slots which is spaced from the first input slot along a circumference of the lamination stack and in a first output layer of the winding layers, wherein the first output portion is interconnected with a second input portion of a second partial strand of the partial strands wherein the second input portion is arranged in a second input slot of the slots and in a second input layer of the winding layers.

17. The winding according to claim 16, wherein the first output layer and the second input layer are arranged adjacent one another.

18. The winding according to claim 16, wherein at least one intermediate layer of the winding layers which is different than the first output layer and the second input layer is arranged between the first output layer and the second input layer.

19. The winding according to claim 13, wherein a further partial strand of the winding is guided through a further input slot and a further output slot within the outer layer.

20. The winding arrangement according to claim 13, wherein the winding corresponds to at least a first partial winding and/or a second partial winding.

21. A component for an electric machine, comprising:
an annular lamination stack with a plurality of axially extending slots through the lamination stack, configured to receive partial strands of a winding in a plurality of radially adjacently arranged winding layers;
wherein the winding comprises:
partial strands of the winding received in the axially extending slots in a plurality of radially adjacently arranged winding layers, wherein the winding layers comprise:
at least one radially outermost outer layer;
a radially innermost inner layer;
at least one second winding layer arranged adjacent the outer layer;
a third winding layer arranged adjacent the second winding layer;
a fourth winding layer arranged adjacent the third winding layer; and
a fifth winding layer which is adjacent the fourth winding layer and is arranged between the fourth winding layer and the inner layer,
wherein an average coil pitch of partial strands of the winding which are guided through the inner layer and through the outer layer or through the second winding layer and the third winding layer differs from another average coil pitch of other partial strands of the winding,
wherein the other partial strands are guided through the fourth winding layer and the fifth winding layer.

22. The component according to claim 21, wherein the component is integrated into the electric machine which is constructed as stator or as rotor of the electric machine and comprises three windings.

23. The component according to claim 22, wherein the electric machine is integrated into an electric axle drive for a motor vehicle having a transmission device and a power converter.

24. A Motor vehicle comprising an electric machine according to claim 22.
